(19) United States
(12) Patent Application Publication
(10) Pub. No.: US 2026/0163662 A1
(43) Pub. Date: Jun. 11, 2026

(54) GENERATIVE ARTIFICIAL INTELLIGENCE (GEN AI)-ASSISTED ADAPTIVE ANTENNA SYSTEM

(71) Applicants: AT&T Intellectual Property I, L.P., Atlanta, GA (US); AT&T Mobility II LLC, Atlanta, GA (US)

(72) Inventors: Charles M. Stahulak, Chicago, IL (US); Daniel Redmond, ELK GROVE, CA (US); Effendi Jubilee, Gaithersburg, MD (US); Ming-Ju Ho, Alpharetta, GA (US)

(73) Assignees: AT&T Intellectual Property I, L.P., Atlanta, GA (US); AT&T Mobility II LLC, Atlanta, GA (US)

(21) Appl. No.: 18/973,363

(22) Filed: Dec. 9, 2024

(51) Int. Cl. H04B 17/391; H01Q 3/00; H04W 16/18; H04W 16/28

(52) U.S. Cl. CPC H04B 17/3913; H01Q 3/005; H04W 16/18; H04W 16/28

(57) ABSTRACT

Aspects of the subject disclosure may include, for example, receiving first data relating to a position or an orientation of one or more adaptive antennas and second data relating to one or more signals received via the one or more adaptive antennas, causing an AI model to generate a prediction for aligning or adjusting the one or more adaptive antennas based on the first data and the second data, and based on the prediction, transmitting a command to an antenna controller unit to cause the one or more adaptive antennas to be aligned or adjusted. Other embodiments are disclosed.

### FIELD OF THE DISCLOSURE

The subject disclosure relates to generative artificial intelligence (Gen AI)-assisted alignment or adjustment of adaptive antennas.

### BACKGROUND

In conventional network setups, optimizing antennas, transmission equipment, cellular systems, and core network components is a complex and time-consuming task. Technicians often spend days or even weeks ensuring that these components and systems meet the necessary thresholds for radio frequency (RF) system health. This process, known as “peaking,” involves the use of specialized tools to fine-tune the equipment. Peaking requires technicians to travel long distances and work in challenging environments, such as climbing tall towers. This is not only time consuming, but also involves significant costs and safety risks. Efficiency of the overall process also heavily depends on the technician's level of skill and experience. Similar challenges arise when deploying cellular networks, where the test and turnup process can also be arduous and lengthy. Teams must remain on-site for extended periods to ensure optimal performance, which can be inefficient and unsafe due to prolonged exposure to potential hazards at high elevations.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within, or operatively overlaid upon, the communications network of FIG. 1 and/or the system of FIG. 2C, in accordance with various aspects described herein.

FIG. 2B illustrates an example adaptive antenna in accordance with various aspects described herein.

FIG. 2C is a block diagram illustrating an example, non-limiting embodiment of a system functioning within, or operatively overlaid upon, the communications network of FIG. 1 and/or the system of FIG. 2A, in accordance with various aspects described herein.

FIG. 2D depicts an illustrative embodiment of a method in accordance with various aspects described herein.

FIG. 2E is a diagram of an example AI architecture, which may be used to facilitate training or pre-training of one or more AI models, including, for instance, large language models (LLMs), in accordance with various aspects described herein.

FIG. 2F is a diagram of an example transformer model, a portion or an entirety of which may serve as a functional building block of one or more LLMs, in accordance with various aspects described herein.

FIG. 3 is a block diagram illustrating an example, non-limiting embodiment of a virtualized communications network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments of generative artificial intelligence (Gen AI)-based control and adjustments of adaptive RF antennas for facilitating network turnup, testing, management, and/or performance improvement or optimization. As described in more detail below, the Gen AI-based functionality may be implemented in or with an adaptive antenna control system that interfaces with one or more AI/machine learning (ML) models. In exemplary embodiments, the Gen AI (which may include one or more large language models (LLMs)) may be utilized in conjunction with various tools and data sources to enable autonomous alignment (or optimization/approximate optimization) of adaptive antennas, RF base station equipment signals at cell/microwave sites, and/or core network equipment. Alignment of an adaptive antenna may involve the adjustment of the orientation and/or positioning of one or more dipoles or crossed-dipoles thereof so as to direct their radiation patterns towards desired signal sources or targets. Such alignment can increase or maximize signal strength and signal quality and reduce interference, thereby providing for efficient communications with network components, such as base stations, core equipment, and/or user equipment (UEs).

The tools and data sources may include key performance indicators (KPIs) or the like (such as signal strength, interference levels, etc., which can be used to determine adaptive antenna adjustment parameters for improving/optimizing performance), sensors and Internet-of-Things (IoT) devices (which can be used to gather real-time or near real-time information and/or feedback, including the orientations/positions of the adaptive antennas), and/or networked tools (such as signal generators, power meters, internal global positioning system (GPS), gimbals, accelerometers, and/or digital levels, which can be used to determine the orientations/positions of the adaptive antennas and/or to facilitate the determination of adaptive antenna adjustment parameters).

Leveraging Gen AI/ML advantageously enables autonomous alignment of adaptive antennas and improvement or optimization of antenna performance. In one or more embodiments, the adaptive antenna control system may integrate or utilize various antenna-related data, including GPS data (i.e., information regarding the geographic location, such as the latitude, longitude, and altitude, of an adaptive antenna, which can inform on the slope of the ground surface beneath the adaptive antenna), bearing data (i.e., directional information, such as degrees relative to a reference direction, that indicates the orientation or direction in which the adaptive antenna is pointed), and/or level data (i.e., information regarding the tilt or inclination of the adaptive antenna) to assist in the alignment of adaptive antennas towards desired signal sources or targets. The AI/ML components enable the adaptive antenna control system to learn from historical data and real-time (or near real-time) feedback to continuously improve its ability to align and improve the performance of the antennas. In various embodiments, the adaptive antenna control system may additionally integrate or utilize cross-polarization (XPOL) techniques to reduce interference between signals of different polarizations, which enables clear and efficient communication channels.

Antennas are essential components in any wireless communication system, especially in mobile communications. They play a critical role in transmitting and receiving signals, converting electrical signals into electromagnetic waves and vice versa. Antenna patterns and power define cell coverage, and their design involves various elements. The dipole acts as a radiating element that emits or receives radio waves with a specific frequency response, while the dipole raiser affects the main lobe of the antenna pattern. The ground plane serves as a reflective layer to improve the radiation pattern and efficiency. Reflectors and directors are used to direct and focus radio waves to a specific direction. A balun converts between balanced and unbalanced signals, ensuring maximum power transfer and minimizing signal loss. The radom is a protective enclosure that shields the antenna from environmental factors and is designed to be transparent to radio waves. A trap isolates different frequency bands, allowing for efficient operations at multiple frequencies. Today, antennas are primarily designed with fixed sizes and electronic adjusters for tilting their coverage patterns. However, advancements in materials and technology are enabling more dynamic and adaptable designs.

In various embodiments, adaptive antennas may be constructed from one or more materials using nanotechnology, which can offer extended longevity post-deployment as well as versatile properties, such as tunable electrical characteristics by way of adjustments to dipole length and/or thickness. The one or more materials may include graphene and/or carbon nanotubes (e.g., electroactive polymers (EAPs)), which offer exceptional electrical and thermal properties that can enhance antenna performance. The one or more materials may additionally, or alternatively, include metamaterials that, when engineered at nanoscale, result in antennas that have unique characteristics, such as negative refractive indices, which can enable miniaturized and highly efficient designs. In one or more embodiments, nanoscale fabrication methods, such as electron beam lithography and/or nanoimprinting may be employed to create highly detailed and precise antenna structures that are not possible with traditional manufacturing techniques. In various embodiments, nano-antennas can be designed to harvest ambient energy, such as solar or electromagnetic energy, that can be used to power themselves or other devices. This can be particularly useful for remote or low-power applications. The nanostructures of the materials, and more particularly the dipole length and/or thickness, may be electrically adjusted to change the electrical or RF characteristics of the dipole element(s), which allows for the creation of different antenna frequency responses.

In various embodiments, the AI/ML model(s) may be trained using supervised learning to recommend adjustments to adaptive antennas that improve or optimize the frequency response characteristics thereof. The adjustments may result in enhanced coverage, improved performance and capacity, improved or optimized spectrum allocation, mitigated interference, and/or increased cost efficiency. In one or more embodiments, the Gen AI may be configured to analyze data from historical implementations, and utilize results of the analysis to generate the recommendations.

As global frequency assignments evolve, challenges, such as frequency congestion, bucking, and the need for Cross Polarization Interference Cancelling (XPIC) in microwave systems will arise, along with the necessity for constant beam shifting and cellular alignment/optimization. Embodiments described herein may create an interconnected ecosystem that involves (e.g., all) aspects of adaptive RF antennas, including antenna and radio technical specifications, core network equipment specifications, onsite test equipment, regulatory compliance (e.g., Universal Licensing System (ULS) and Federal Communications Commission (FCC) compliance, such as that relating to High Voltage Frequency (HVF), frequencies, etc.), geographic data (e.g., latitude, longitude, elevation), telemetry and controls, spatial and weather data gathering devices, and/or microwave/cellular radio health. This comprehensive approach enables continuous improvement (or optimization) towards a constant antenna peak in an efficient way.

Exemplary embodiments of the Gen AI-based method provide for robust, efficient, and user-friendly improvement in the performance of networks that operate in licensed or unlicensed spectrum, such as wireless (e.g., Wi-Fi) networks (which connect devices within a local area), core networks (which serve as backbones of telecommunications networks for data routing and switching), wireless wide area networks (WWANs) (which cover large geographic areas using cellular technology), radio access networks (RANs) (which connect individual devices to the core network), worldwide RANs (WW-RANs) (which are global extensions of RANs for international connectivity), or the like.

In one or more embodiments, the Gen AI-based adaptive antenna control system may be capable of adjusting and/or customizing the adaptive antenna system of a given cell (e.g., in real-time or near real-time) based on network parameters, KPIs, interference, noise, traffic distribution information, and/or other network-related information. This advantageously enhances coverage, improves performance and capacity, improves or optimizes spectrum allocation, mitigates interference, increases cost efficiency, conserves energy, and contributes to more environmentally friendly operations.

The fabrication of adaptive antenna systems whose properties can be dynamically adjusted by way of Gen AI advantageously reduces or eliminates the need to change out cellular antennas post-deployment if different frequency responses are later desired. Further, leveraging Gen AI enables autonomous optimization of adaptive RF antennas and network equipment, which helps predict and mitigate interference, balance loads, and improve cross-border data transmissions, thereby significantly reducing the time, cost, and effort that would otherwise be required for manual optimization. The integration of Gen AI for self-turnup and self-optimization also allows technicians to mount antennas and install equipment with the confidence that the system will handle the turnup and optimization processes autonomously. This reduces the need for prolonged technical trips and extended periods on towers, which reduces exposure to safety risks at high elevations. Embodiments described herein ensure consistent equipment performance, reduce optimization times, and allow maintenance crews to complete tasks more efficiently.

Various embodiments also enable improved or optimized microwave backhauls for cell sites, which reduces costs associated with building and maintaining such infrastructures. Wireless and wireline telecommunications carriers deploying microwave radio as a backhaul for cell sites or wireline services can thus achieve significant operational savings.

It will be understood and appreciated that embodiments of the Gen AI-based adaptive antenna control system can be utilized or adapted for use with any type of communication system involving the use of antennas, such as satellite systems, Non-line-of-sight (NLOS) radio systems, broadcast microwave systems, amplitude modulation (AM)/frequency modulation (FM) radio systems, military systems, and so on.

Furthermore, aspects of the Gen AI-based adaptive antenna control system also apply to improvements or optimizations of various network-related devices, such as, for instance, crossband combiners, Tower Mounted Amplifiers (TMAs), filters, and so on. A crossband combiner is a device that allows multiple frequency bands to be combined and transmitted through a single antenna, and is typically used to improve or optimize the use of available spectrum and to reduce the need for multiple antennas. The adaptive antenna control system can be implemented in a crossband combiner to dynamically adjust the frequency bands that are being combined based on real-time network conditions and/or performance metrics. A TMA is an amplifier that is mounted at the top of a cell tower, proximate to an antenna, to improve the signal-to-noise ratio (SNR) of received signals. The TMA amplifies weak signals before they are transmitted down the tower, which reduces signal loss and improves overall reception quality. The adaptive antenna control system can be integrated with a TMA to dynamically adjust the amplification levels based on real-time signal strength and/or interference data. Filters selectively allow certain frequencies to pass through while blocking others, which can help eliminate unwanted signals and interference. The adaptive antenna control system can be implemented in a filter to dynamically adjust the filtering parameters based on real-time network conditions and/or performance metrics.

One or more aspects of the subject disclosure include a device, comprising a processing system including a processor, and a memory that stores executable instructions that, when executed by the processing system, facilitate performance of operations. The operations can include receiving first data relating to a position or an orientation of one or more adaptive antennas and second data relating to one or more signals received via the one or more adaptive antennas. Further, the operations can include causing an AI model to generate a prediction for aligning or adjusting the one or more adaptive antennas based on the first data and the second data. Further, the operations can include based on the prediction, transmitting a command to an antenna controller unit to cause the one or more adaptive antennas to be aligned or adjusted.

One or more aspects of the subject disclosure include a non-transitory machine-readable medium, comprising executable instructions that, when executed by a processing system including a processor, facilitate performance of operations. The operations can include receiving first data relating to a position or an orientation of one or more adaptive antennas and second data relating to one or more signals received via the one or more adaptive antennas, wherein the one or more adaptive antennas are composed of nanomaterial having a physical structure that is adjustable. Further, the operations can include causing an AI model to generate a prediction for modifying the physical structure based on the first data and the second data. Further, the operations can include based on the prediction, transmitting a command to an antenna controller unit to cause the physical structure to become adjusted.

One or more aspects of the subject disclosure include a method. The method can comprise receiving, by a processing system including a processor, first data relating to a position or an orientation of one or more adaptive antennas and second data relating to one or more signals received via the one or more adaptive antennas. Further, the method can include causing, by the processing system, an AI model to generate a prediction for adjusting the position or the orientation of the one or more adaptive antennas based on the first data and the second data. Further, the method can include based on the prediction, transmitting, by the processing system, a command to an antenna controller unit to cause the position or the orientation of the one or more adaptive antennas to be adjusted.

Other embodiments are described in the subject disclosure.

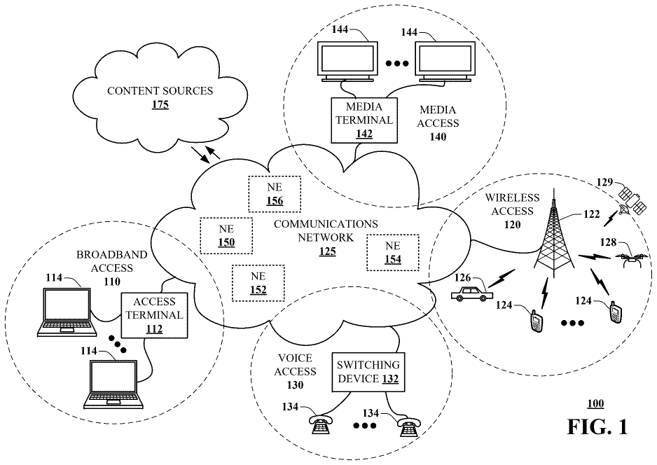

Referring now to FIG. 1, a block diagram is shown illustrating an example, non-limiting embodiment of a system 100 in accordance with various aspects described herein. For example, system 100 can facilitate, in whole or in part, Gen AI-assisted alignment or adjustment of adaptive antenna(s). In particular, a communications network 125 is presented for providing broadband access 110 to a plurality of data terminals 114 via access terminal 112, wireless access 120 to a plurality of mobile devices 124, vehicle 126, and uncrewed aerial vehicle (UAV) 128 via base station or access point 122 (and/or via satellite(s) 129), voice access 130 to a plurality of telephony devices 134, via switching device 132 and/or media access 140 to a plurality of audio/video display devices 144 via media terminal 142. In addition, communications network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or another communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices. In various embodiments, the satellite(s) 129 can be configured for bi-directional communication with one or more access points, with one or more base stations, and/or with one or more mobile devices (e.g., direct-to-cell). In various embodiments, the satellite(s) 129 can include one or more Low Earth Orbit (LEO) satellites or one or more Geostationary Orbit (GEO) satellites.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

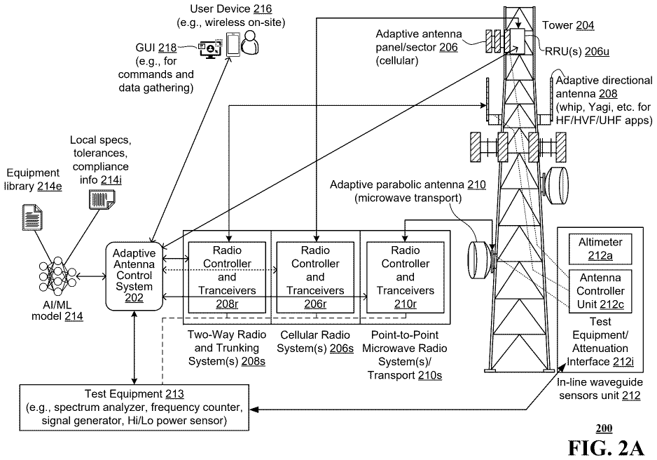

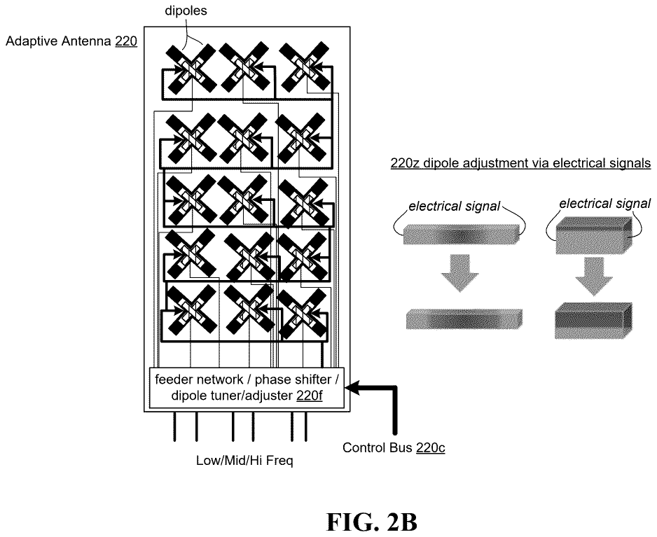

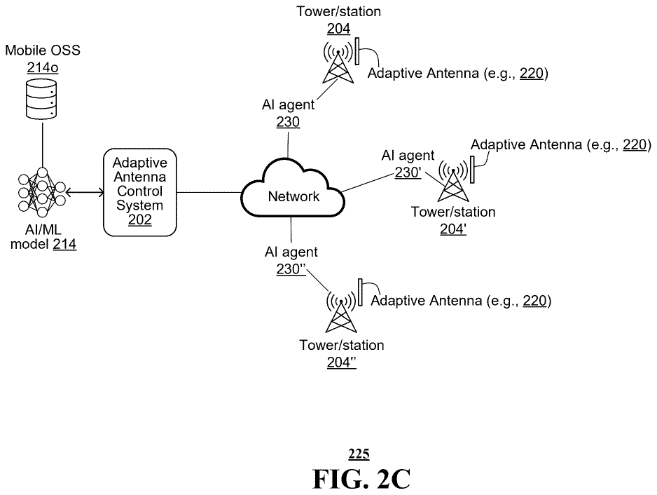

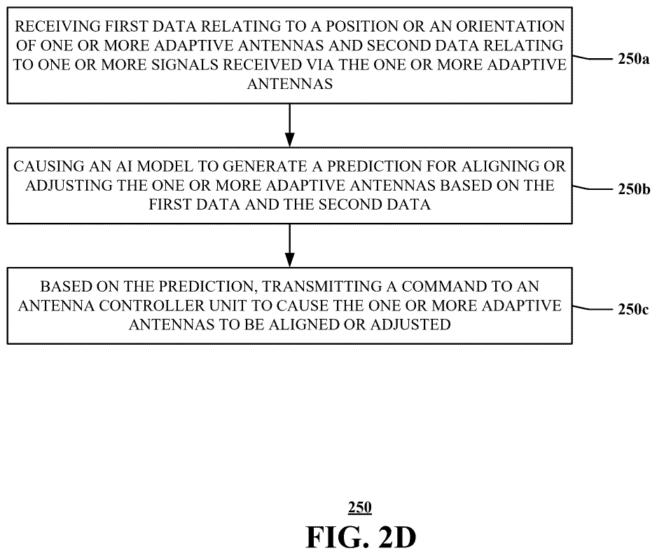

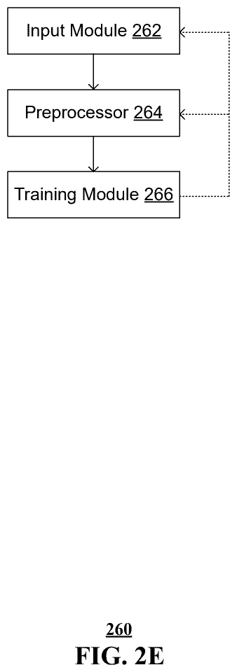

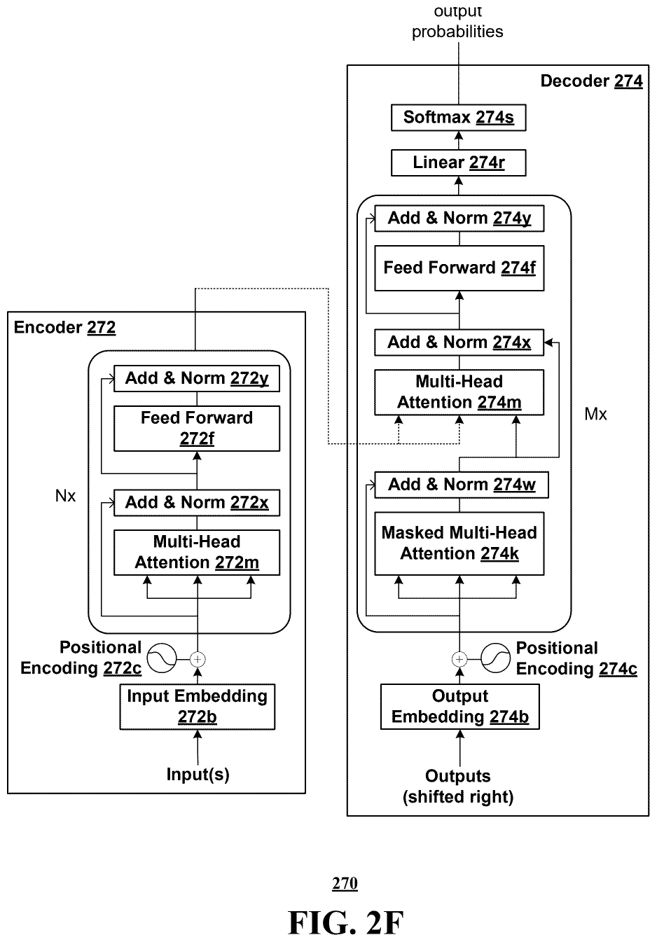

FIG. 2A is a block diagram illustrating an example, non-limiting embodiment of a system 200 functioning within, or operatively overlaid upon, the communications network 100 of FIG. 1 and/or the system 225 of FIG. 2C, in accordance with various aspects described herein. The system 200 may include an adaptive antenna control system 202, an AI/ML model 214, and a tower 204.

The tower 204 may include various adaptive antennas coupled to or mounted thereon, such as one or more adaptive antenna panels/sectors 206 for facilitating cellular communications, one or more adaptive directional antennas 208 for two-way radio and trunking communications (e.g., whip, Yagi, etc. for high frequency (HF)/HVF/ultra-high frequency (UHF) applications), and one or more adaptive parabolic antennas 210 for point-to-point microwave communications. The adaptive antenna panel(s)/sector(s) 206 may be communicatively coupled, by way of remote radio unit(s) (RRU(s)) 206u, to a radio controller and transceivers system 206r of cellular radio system(s) 206s that is configured to manage the transmission and reception of cellular signals. The RRU(s) 206u may be configured to convert digital signals to radio frequency signals and vice versa, and may be positioned proximate to the adaptive antenna panel(s)/sector(s) 206 so as to reduce or minimize signal loss and improve efficiency. The adaptive directional antenna(s) 208 may be communicatively coupled to a radio controller and transceivers system 208r of two-way radio and trunking system(s) 208s that is configured to handle communications processes for HF, HVF, and/or UHF applications. The adaptive parabolic antenna(s) 210 may be communicatively coupled to a radio controller and transceivers system 210r of point-to-point microwave radio system(s) 210s that is configured to manage microwave signal transmission and reception for a backhaul transport. The radio controller and transceivers system 206r, the radio controller and transceivers system 208r, and/or the radio controller and transceivers system 210r may be positioned proximate to the ground, such as at the base of the tower 204 or in a nearby building or other enclosed structure.

The tower 204 may represent a base station that is part of an access network. The access network may include network resources, such as one or more physical resources (or network nodes). Base stations may include one or more eNodeBs (eNBs), one or more gNodeBs (gNBs), and/or the like. In various embodiments, the physical resources may additionally, or alternatively, include one or more satellites and/or uncrewed aerial vehicles (UAVs), one or more Gigabyte Passive Optical Networks (GPONs) and/or related components (e.g., Optical Line Terminal(s) (OLT), Optical Network Unit(s) (ONU), etc.), and/or the like. A base station may employ any suitable radio access technology (RAT), such as long term evolution (LTE), 5G, 6G, or any higher generation RAT. In various embodiments, the access network can include various types of heterogeneous cell configurations with various quantities of cells and/or types of cells. The access network may be in communication with core network(s) via intermediate links provided by backhaul or transport network(s). The transport network(s) may include traditional transport network technologies, such as optical fibers, microwave links, wireless point-to-point technologies, etc.

A core network may include various network devices and/or systems that provide a variety of functions. Examples of functions provided by, or included, in a core network include an access mobility and management function (AMF) configured to facilitate mobility management in a control plane of the system 200, a User Plane Function (UPF) configured to provide access to a data network (such as a packet data network (PDN) in a user (or data) plane of the system 200), a Unified Data Management (UDM) function, a Session Management Function (SMF), a Policy Control Function (PCF), and/or the like. For instance, a core network may include an evolved packet core (EPC) (associated with a mobility management entity (MME)), a 5G core (5GC) (associated with an SMF), a 6G core (6GC) (associated with a control plane function (CPF)), and/or a Broadband Network Gateway (BNG). In various embodiments, a core network may include one or more devices implementing other functions, such as a master user database server device for network access management, a PDN gateway server device for facilitating access to a PDN, and/or the like. A core network may be in further communication with one or more other networks (e.g., one or more content delivery networks (CDNs)), one or more services, and/or one or more devices. In one or more embodiments, a core network may be implemented in distributed cores.

It is to be understood and appreciated that the system 200 can include any number/type of access network (e.g., any number/type of physical resources) and any number/type of core network (e.g., any number/type of cores, interfaces, etc.), and thus the number/types of these networks and their components illustrated in, or described with respect to, FIG. 2A are for illustrative purposes only.

The system 200 may include tool(s) for obtaining measurements or other information regarding some or all of the adaptive antenna panel(s)/sector(s) 206, the adaptive directional antenna(s) 208, and the adaptive parabolic antenna(s) 210. In various embodiments, the tool(s) may include digital bearing and level reading system(s) and/or other sensors or IoT devices that are configured to monitor and detect the orientation of a given adaptive antenna, such as an azimuth angle and/or an elevation of tilt angle thereof. As some non-limiting examples, the tool(s) may include one or more digital inclinometers, one or more digital compasses, one or more GPS modules, one or more accelerometers, one or more gyroscopes, and/or the like.

In one or more embodiments, the tool(s) may include an in-line waveguide sensors unit 212, which may include an altimeter 212a, an antenna controller unit 212c, and a test equipment/attenuation interface 212i. The altimeter 212a may be configured to measure the height of one or more of the adaptive antennas above the ground level. In some embodiments, some or all of the above-described digital bearing and level reading system(s) and/or other sensors or IoT devices may be included in or otherwise communicatively coupled to the in-line waveguide sensors unit 212. The antenna controller unit 212c may be communicatively coupled to one or more of the adaptive antennas, and more particularly adjustment mechanisms coupled to the adaptive antenna(s) (e.g., motors, drivers, etc.), for controlling movement of the adaptive antenna(s). In certain embodiments, individual dipoles of an adaptive antenna may be coupled to respective adjustment mechanisms for selective adjustment of the dipoles. The test equipment/attenuation interface 212i may be configured to communicatively couple the antenna controller unit 212c, the altimeter 212a, and/or the other sensors or IoT devices to a test equipment system 213. In one or more embodiments, the test equipment system 213 may be communicatively coupled with one or more of the radio controller and transceivers 206r, 208r, and 210r. The test equipment system 213 may include one or more devices, such as a spectrum analyzer, a frequency counter, a signal generator, a Hi/Lo power sensor, etc., which can operate on signals/data received from the radio controller and transceivers 206r, 208r, and/or 210r to perform measurements such as signal strength, signal quality, interference levels, and/or other performance metrics, and can derive signals for controlling the adjustment mechanisms of the adaptive antenna(s).

The adaptive antenna control system 202 may be configured to facilitate coordinated control/adjustment of some or all of the adaptive antennas. The adaptive antenna control system 202 may be a central component that interfaces with the AI/ML model 214 as well as with one or more other systems/devices, such as the radio controller and transceivers 206r, 208r, and 210r and/or the test equipment system 213. The AI/ML model 214 may be trained to provide intelligent decision-making capabilities for improving or optimizing antenna performance. In various embodiments, the AI/ML model 214 may be trained via an AI architecture (e.g., an AI architecture 260 illustrated in FIG. 2E and described in more detail below). In certain embodiments, the AI/ML model 214 may include one or more LLMs, such as an LLM that is based on the transformer model 270 illustrated in FIG. 2F and described in more detail below.

Embodiments of the adaptive antenna control system 202 may facilitate the dynamic adjustment of adaptive antenna-related parameters, particularly the orientation and/or positioning of adaptive antenna(s), based on real-time (or near real-time) measurement data and based on predictions generated by the AI/ML model 214. For instance, the adaptive antenna control system 202 may obtain, from the test equipment 213 and the various sensors/IoT devices, digital bearing and level measurements as well as signal-related information (signal strength, interference levels, etc.) associated with one or more dipoles of an adaptive antenna. The adaptive antenna may be an adaptive parabolic antenna 210 (microwave), an adaptive antenna panel 206 (cellular), or an adaptive directional antenna 208. The adaptive antenna control system 202 may provide the obtained measurement data and signal-related information to the AI/ML model 214 for analysis. The AI/ML model 214 may compare the data and information with known specifications, tolerances, etc. associated with the adaptive antenna to identify appropriate adjustments that can be made thereto to arrive at desired performance metric data. For instance, the AI/ML model 214 may, based on its training, determine that the current azimuth angle of the one or more dipoles of the adaptive antenna can be adjusted by a certain amount to improve signal strength by a particular amount. In such a case, the AI/ML model 214 may output an adjustment prediction for adjusting the azimuth angle of the dipole(s) of the adaptive antenna accordingly. The adjustment prediction may be in the form of an instruction that the antenna controller unit 212c can utilize to make the necessary adjustment—e.g., an instruction to drive a motor by a particular amount. As an example, the AI/ML model 214 may be trained to correlate a rotation of a motor of the adaptive antenna by 1 degree with an improvement in signal strength associated with a received signal by a specific percentage or decibel (dB) value. Some or all of the training may be based on datasets included in an equipment library 214e and/or local specifications, tolerances, compliance information 214i. The adaptive antenna control system 202 may receive the instruction from the AI/ML model 214, and may transmit the instruction to the antenna controller unit 212c to effect the corresponding adjustment for the adaptive antenna. By autonomously adjusting alignment of the adaptive antenna, the adaptive antenna control system 202 may thus advantageously improve received signal strength and overall network performance. This conserves computing resources and power resources that would otherwise be wasted on inefficient data transmissions.

In various embodiments, the adaptive antenna control system 202 may integrate or utilize cross-polarization (XPOL) techniques to reduce interference between signals of different polarizations. The AI/ML model 214 may be trained to determine, or configured with predefined rules or algorithms that dictate, how to set polarizations of different adaptive antennas depending on specific conditions. For example, the training or rules may indicate that particular orthogonal polarizations are to be used for adaptive antennas that are positioned a particular distance away from one another so as to reduce cross-polarization interference. In certain embodiments, the AI/ML model 214 may be trained to, or configured with predefined rules or algorithms that, factor in environmental and/or geographic data, such as the presence of physical obstructions, terrain, and/or weather conditions, when analyzing signal propagation and polarization, which can further aid in setting the appropriate polarization for each individual adaptive antenna.

In one or more embodiments, the adaptive antenna control system 202 may be a Retrieval-Augmented Generation (RAG)-based system that has access to the equipment library 214e and/or the local specifications, tolerances, and compliance information 214i on an as-needed basis. In one or more alternate embodiments, the AI/ML model 214 may be (e.g., periodically) fed some or all of the data in the equipment library 214e and/or the local specifications, tolerances, compliance information 214i for fine-tuning of the AI/ML model 214 to understand and incorporate such data into its predictions.

FIG. 2B illustrates an example adaptive antenna 220 in accordance with various aspects described herein. The adaptive antenna 220 may correspond to or may be included in any of the adaptive antenna panel(s)/sector(s) 206, the adaptive directional antenna(s) 208, and the adaptive parabolic antenna(s) 210. The dipoles of the adaptive antenna 220 may be constructed from one or more materials using nanotechnology. The one or more materials may include graphene and/or EAPs. The one or more materials may additionally, or alternatively, include metamaterials that, when engineered at nanoscale, result in antennas that have unique characteristics, such as negative refractive indices. In one or more embodiments, nanoscale fabrication methods, such as electron beam lithography and/or nanoimprinting, may be employed to create highly detailed and precise antenna structures. As shown by reference number 220z, the nanostructures of the materials, and more particularly the dipole length and/or thickness, may be electrically adjusted to change the electrical or RF characteristics of the dipole element(s), allowing for the creation of different antenna frequency responses. A dipole-raiser can be electrically manipulated—e.g., by way of a corresponding line of a feeder network/phase shifter/dipole tuner/adjuster 220f and via electrical signals transmitted by the antenna controller unit 212c over a control bus 220c—to adjust the dipole length and/or thickness for specifically tuning or modifying the main lobe of an antenna pattern associated with the dipole.

Embodiments of the adaptive antenna control system 202 may facilitate the dynamic adjustment of adaptive antenna-related parameters, particularly the structure of the dipole(s) of adaptive antenna(s), based on real-time (or near real-time) measurement data and based on predictions generated by the AI/ML model 214. For instance, the adaptive antenna control system 202 may obtain, from the test equipment 213 and the various sensors/IoT devices, digital bearing and level measurements as well as signal-related information (signal strength, interference levels, etc.) associated with one or more dipoles of an adaptive antenna. The adaptive antenna may be an adaptive parabolic antenna 210 (microwave), an adaptive antenna panel 206 (cellular), or an adaptive directional antenna 208. The adaptive antenna control system 202 may provide the obtained measurement data and signal-related information to the AI/ML model 214 for analysis. The AI/ML model 214 may compare the data and information with known specifications, tolerances, etc. associated with the dipole(s) of the adaptive antenna to identify appropriate adjustments that can be made thereto to arrive at desired performance metric data. For instance, the AI/ML model 214 may, based on its training, determine that the current structure of a dipole of the adaptive antenna can be adjusted (enlarged or shrunken) by a certain amount to obtain a desired frequency response from the dipole. In a case where the signal strength is low (e.g., below a threshold), the AI/ML model 214 may recommend changing the frequency response of the antenna to avoid interference from other signals in particular frequencies. In one example, the AI/ML model 214 may output electrical signal information that can be used by the antenna controller unit 212c to generate electrical signals for modifying the dipole length and/or thickness accordingly. The AI/ML model 214 can thus identify the appropriate nanomaterial(s) of the dipole(s), the desired frequency response, and the necessary electrical signals to change the frequency band of the dipole(s) from a current frequency band to another frequency band, allowing for improved received signal strength.

The adaptive antenna control system 202 has thus far been described as including or utilizing Gen AI and/or algorithm(s) to that facilitate autonomous adjustments to adaptive antennas of a WWAN. In certain embodiments, the adaptive antenna control system 202 may be configured to generate and provide reports on the obtained digital bearing and level measurements, the obtained signal-related information, and/or the corresponding adjustments that are made to the adaptive antennas. As some non-limiting examples, the adaptive antenna control system 202 may generate a report that presents a main lobe and a side lobe of an antenna radiation pattern in the azimuth (e.g., x-axis) and elevation or tilt (e.g., y-axis) directions, a report on cross-polarization settings (e.g., a first polarization used for one adaptive antenna and a second orthogonal polarization used for another adaptive antenna), a report showing receive signal level (RSL) graph(s) that portray the strength of a received signal at an adaptive antenna over time or across different conditions, a report showing fade graph(s) that portray the variations in signal strength due to “fading” (i.e., fluctuations in signal strength over time due to factors such as multipath propagation, atmospheric conditions, and/or physical obstructions), health and performance reports, beamforming reports, and/or the like. Referring again to FIG. 2A, the adaptive antenna control system 202 may provide a graphical user interface (GUI) 218 for display on a user device 216 (e.g., wireless on-site). The GUI 218 may display the report(s) that are generated and provided by the adaptive antenna control system 202.

In various embodiments, the adaptive antenna control system 202 may additionally allow for manual intervention in the adjustment process so as to facilitate technician-guided alignment or optimization. Particularly, the GUI 218 may be configured to enable a user (e.g., a technician) to input commands to the adaptive antenna control system 202. For instance, based on a user command to the GUI 218 to initiate adaptive antenna adjustments, the adaptive antenna control system 202 may (e.g., in coordination with the AI/ML model 214) obtain adaptive antenna information—e.g., radiation patterns, determined/guided ranges or extremes in azimuth, elevation, and height, etc.—and may prompt or alert the user with some or all of the information, or derivations based on the information, so as to allow the user to ascertain or visualize parameters, such as the main lobe, the side lobe(s), desired or optimal points, receive signal levels, and so on. The GUI 218 may present information regarding current and/or prior alignments, such as data regarding the signal strength prior to alignment, data regarding the electrical signal(s) that were or that will be sent to the antenna controller unit 212c to modify a structure of one or more adaptive antenna dipoles or to rotate a motor attached thereto, etc.

In one or more embodiments, the above-described digital bearing and level reading system may be (e.g., automatically) calibrated via a positioning and bearing sensor or digital compass that can report True or Magnetic north. In certain embodiments, the digital bearing and level reading system may be further calibratable based on data from an internal GPS or based on GPS data that is user-inputted via the GUI 218 (in manual override mode).

In certain example implementations, the adaptive antenna control system 202 and its associated devices or components, such as the in-line waveguide sensors unit 212, the test equipment 213, and/or another network management system, may be configured to facilitate adaptive monitoring of adaptive antenna-related measurements and associated RF signals. For instance, the adaptive antenna control system 202 may, based on received data relating to an adaptive antenna, perform an analysis relating to the received data. As an example, the adaptive antenna control system 202 may compare the received data with historical data to determine whether a difference between the received data and the historical data (e.g., differences in received signal strength, differences in interference level, etc.) is less than a predetermined threshold. Where the adaptive antenna control system 202 determines that the difference between the received data and the historical data is not less than the predetermined threshold, the adaptive antenna control system 202 may cause the in-line waveguide sensors unit 212, the test equipment 213, and/or another network management system to obtain additional data relating to the adaptive antenna. This additional data may relate to the status of any communication sessions that are associated with the adaptive antenna, such as error logs, session statistics, signal source or target (e.g., UE) locations, and/or the like. The adaptive antenna control system 202 may analyze this additional data to identify potential factors that may have led to the above-threshold differences, which can inform the adaptive antenna control system 202 on particular adjustments that can be made for the adaptive antenna (e.g., increasing power, etc.). The adaptive antenna control system 202 may then provide commands regarding such adjustments to the in-line waveguide sensors unit 212 and/or the test equipment 213 for implementation. In this way, the adaptive antenna control system 202 may limit its collection of additional data relating to the adaptive antenna to when the initially received data reflects a poor or abnormal condition. This reduces excess requests for data, which avoids excess traffic volume over the network that could otherwise negatively impact network performance. If the adaptive antenna control system 202 determines that the abnormal condition is no longer present (i.e., the threshold is no longer being exceeded), the adaptive antenna control system 202 can cease the collection of additional data from the in-line waveguide sensors unit 212, the test equipment 213, and/or other network management system, thereby further improving or optimizing network performance and reducing unnecessary data traffic. The additional data can be used to analyze the cause of the poor or abnormal condition, thereby providing an improvement over existing adaptive antenna-related management methods, resulting in a practical application that enhances overall network/device performance monitoring.

FIG. 2C is a block diagram illustrating an example, non-limiting embodiment of a system 225 functioning within, or operatively overlaid upon, the communications network 100 of FIG. 1 and/or the system 200 of FIG. 2A, in accordance with various aspects described herein. Particularly, FIG. 2C illustrates an implementation in which the adaptive antenna control system 202 and the AI/ML model 214 may be used to facilitate adaptive antenna alignments or optimization for multiple cell sites—i.e., different adaptive antennas 220 on or at different towers/stations, such as towers/stations 204, 204′, 204″, etc. Here, one or more of the towers/stations may be configured with an AI agent (230, 230′, 230″, etc.) that interfaces with the adaptive antenna control system 202 (e.g., over a network). The AI agent may be implemented in adaptive antenna-related systems, such as cellular radio system(s), two-way radio and trunking system(s), point-to-point microwave radio system(s), and/or the like, and may pass signal-related information as well as adaptive antenna-related information (e.g., signal measurements, interference level measurements, adaptive antenna position/orientation data, etc.) to the adaptive antenna control system 202 for use in determining necessary adjustments to the adaptive antennas 220.

As illustrated in FIG. 2C, the AI/ML model 214 may be communicatively coupled with Mobile Operations Support Systems (OSS) to receive a variety of information that the AI/ML model 214 can utilized or be trained with for predicting antenna adjustments. The information may include traffic distribution information that identifies areas of congestion or underutilization, KPIs (e.g., signal strength, signal quality, and interference levels), network topology data (e.g., the physical and logical arrangement of network elements), real-time (or near real-time) and historical data on user behavior, such as call drop rates, data usage patterns, and mobility trends, and so on. Integrating such information with the AI/ML model 214 provides for dynamic and intelligent enhancement of network coverage, performance, and capacity, allows for new technologies and frequency bands to be accommodated (e.g., without requiring antenna replacements), and improves or optimizes spectrum allocation and interference mitigation.

While FIG. 2C depicts the adaptive antenna control system 202 and the AI/ML model 214 as each being a singular entity, these may alternatively be implemented in a distributed manner where a respective adaptive antenna control system 202 and/or a respective AI/ML model 214 are dedicated for each AI agent. As an example, one adaptive antenna control system 202 may be dedicated for the AI agent 230, another adaptive antenna control system 202 may be dedicated for the AI agent 230, etc., where a single AI/ML model 214 is interfaced with these adaptive antenna control systems 202. As another example, one adaptive antenna control system 202 and a corresponding AI/ML model 214 may be dedicated for the AI agent 230, another adaptive antenna control system 202 and a another corresponding AI/ML model 214 may be dedicated for the AI agent 230′, etc.

It is to be understood and appreciated that, although one or more of FIGS. 2A and 2C might be described above as pertaining to various processes and/or actions that are performed in a particular order, some of these processes and/or actions may occur in different orders and/or concurrently with other processes and/or actions from what is depicted and described above. Moreover, not all of these processes and/or actions may be required to implement the systems and/or methods described herein. Furthermore, while various systems, devices, models, equipment, units, agents, etc. may have been illustrated in one or more of FIGS. 2A and 2C as separate systems, devices, models, equipment, units, agents, etc., it will be appreciated that multiple systems, devices, models, equipment, units, agents, etc. can be implemented as a single system, device, model, equipment, unit, agent, etc., or a single system, device, model, equipment, unit, agent, etc. can be implemented as multiple systems, devices, models, equipment, units, agents, etc. Additionally, functions described as being performed by one system, device, model, equipment, unit, agent, etc. may be performed by multiple systems, devices, models, equipment, units, agents, etc., or functions described as being performed by multiple systems, devices, models, equipment, units, agents, etc. may be performed by a single system, device, model, equipment, unit, agent, etc.

FIG. 2D depicts an illustrative embodiment of a method 250 in accordance with various aspects described herein.

At 250a, the method can include receiving first data relating to a position or an orientation of one or more adaptive antennas and second data relating to one or more signals received via the one or more adaptive antennas. For example, the adaptive antenna control system 202 can, similar to that described above with respect to the system 200 of FIG. 2A, perform one or more operations that include receiving first data relating to a position or an orientation of one or more adaptive antennas and second data relating to one or more signals received via the one or more adaptive antennas.

At 250b, the method can include causing an AI model to generate a prediction for aligning or adjusting the one or more adaptive antennas based on the first data and the second data. For example, the adaptive antenna control system 202 can, similar to that described above with respect to the system 200 of FIG. 2A, perform one or more operations that include causing an AI model 214 to generate a prediction for aligning or adjusting the one or more adaptive antennas based on the first data and the second data.

At 250c, the method can include based on the prediction, transmitting a command to an antenna controller unit to cause the one or more adaptive antennas to be aligned or adjusted. For example, the adaptive antenna control system 202 can, similar to that described above with respect to the system 200 of FIG. 2A, perform one or more operations that include based on the prediction, transmitting a command to an antenna controller unit 212c to cause the one or more adaptive antennas to be aligned or adjusted.

While for purposes of simplicity of explanation, the respective processes are shown and described as a series of blocks in FIG. 2D, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

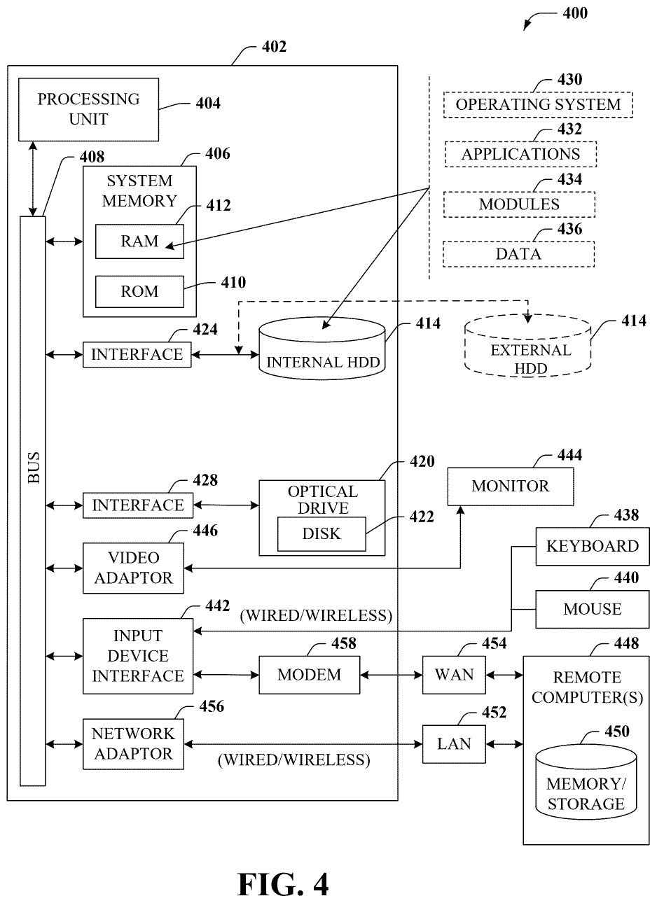

Referring to FIG. 2E, an example AI architecture 260 may be used to facilitate training and/or pre-training of AI models, such as AI model(s) described above with respect to one or more of FIGS. 2A and 2C. For instance, the AI architecture 260 may be used to facilitate training and/or pre-training of an LLM associated with the adaptive antenna control system 202, such as the AI/ML model 214, which may be or may include an LLM that is based on the transformer model 270 illustrated in FIG. 2F and described in more detail below. The AI architecture 260 may include an input module 262, a preprocessor 264, and a training module 266. Some or all of these modules, which may be referred to as programs, processors, or agents, may be realized based on execution of instructions or data by one or more processors of a computing (or ML) system, such as the computing system 400 of FIG. 4 (described in more detail below).

The input module 262 may allow for input of (e.g., user-provided) data, such as datasets, parameters (e.g., weights, biases, and/or the like), etc., that can be used to train models and/or obtain predictions from models. In some cases, datasets may be labeled and may include inputs (e.g., observed or measured values) and known output data. Labeled datasets may facilitate supervised (or guided) learning.

Although not shown, the AI architecture 260 may include a library of ML models or algorithms, such as, for instance, one or more classifiers (e.g., a naïve Bayes classifier or the like), one or more support vector machines, one or more artificial neural networks (e.g., transformer neural networks, convolutional neural networks, and/or the like), one or more learned decision trees, and so on. Each of the ML algorithms may be associated with various parameters.

The preprocessor 264 may be equipped with one or more preprocessing algorithms that are configured to prepare input datasets for processing by the training module 266. Such preprocessing may include discretization (where values are binned or converted into nominal values), component analysis, data estimation, feature selection, feature extraction (e.g., dimensionality reduction, data removal, statistical analysis, threshold-based filtering, etc.), data interpolation, and/or the like.

The training module 266 may be configured to train and evaluate ML models. As an example, the training module 266 may be configured to perform unsupervised learning and/or supervised learning based in input datasets. In exemplary embodiments, the training module 266 may be capable of training and/or evaluating the performance of multiple models in parallel. In one or more implementations, the training module 266 may, despite operating on multiple ML models in parallel, train and evaluate the various ML models individually. In some implementations, the training module 266 may be capable of combining the procedure outcomes of multiple models to derive an aggregate outcome. Model evaluation or validation may involve a comparison of model outputs to known outputs or an analysis of model outputs relative to desired metrics.

In exemplary embodiments, certain processing techniques may be employed to generate usable data sets for feeding into the AI architecture 260 to train deep learning neural network model(s) to output predictions. Although not shown, the AI architecture 260 may include additional functional modules, such as those for gathering performance results and presenting (e.g., displaying) data regarding the results. While various components, modules, etc. may have been illustrated in FIG. 2E as separate components, modules, etc., it will be appreciated that multiple components, modules, etc. may be implemented as a single component, module, etc., or a single component, module, etc. may be implemented as multiple components, modules, etc. Additionally, functions described as being performed by one component, module, etc. may be performed by multiple components, modules, etc., or functions described as being performed by multiple components, modules, etc. may be performed by a single component, module, etc.

Referring to FIG. 2F, an example transformer model 270 (a portion or an entirety of which may serve as a functional building block of one or more LLMs (e.g., LLM(s) associated with or included in the adaptive antenna control system 202, such as the AI/ML model 214 described above with respect to one or more of FIGS. 2A and 2C)) may include an encoder 272 and a decoder 274. The encoder 272 may include an input embedding block 272b, a positional encoder 272c, and a series of (i.e., multiple (Nx)) identical layers that each has a multi-head attention block 272m and a feed forward block 272f. An input (e.g., text, such as a query or a prompt) may be converted into individual tokens (e.g., words, characters, etc.) that are fed into the input embedding block 272b. The input embedding block 272b may convert the tokens into continuous vectors, where each token is mapped to a high-dimensional space by way of a learned embedding matrix. The embedding matrix may be implemented in a lookup table or the like, where token indexes are associated with different vectors of a fixed size. The positional encoder 272c may derive fixed positional encodings or learned positional encodings to help capture positional information of tokens. Fixed positioning encodings may be generated using sinusoidal functions, where the different frequencies of sine/cosine functions correspond to unique positional encodings for the different positions in a given sequence. Learned positional encodings may be learned during training based on initially randomly chosen values that are optimized as part of the training process. In any case, the positional encodings may be combined with the input embeddings from the input embedding block 272b on an element-by-element basis, resulting in a processed input that may be fed into the series of layers. The processed input may be fed into the multi-head attention block 272m in the first layer. An addition (or residual connection) and normalization block 272x may operate on the processed input and the output of that multi-head attention block 272m. The output of the addition and normalization block 272x may be passed to the feed forward block 272f in that layer. An addition and normalization block 272y may operate on the output of the addition and normalization block 272x and the output of the feed forward block 272f. In essence, the multi-head attention block 272m of a given layer may enable the feed forward block 272f in that layer to model long term dependencies. Multi-head attention allows the model to simultaneously attend to different parts of the input sequence and weigh their importance based on the input sequence's internal relationships. This attention mechanism may be combined with the input sequence's representations to produce a new set of weighted representations. Iterating the identical layers allows the model to learn complex patterns and relationships in the data.

The decoder 274 may include an output embedding block 274b, a positional encoder 274c, and a series of (i.e., multiple (Mx)) identical layers that each has a masked multi-head attention block 274k, a multi head attention block 274m, and a feed forward block 274f. An output (shifted right) may be converted into individual tokens that are fed into the output embedding block 274b. The output embedding block 274b may convert the tokens into continuous vectors. The positional encoder 274c may derive fixed positional encodings or learned positional encodings to help capture positional information of tokens. The processed output may be fed into the masked multi-head attention block 274k in the first layer. An addition and normalization block 274w may operate on the processed output and the output of that masked multi-head attention block 274k. The output of the addition and normalization block 274w may be passed to the multi-head attention block 274m in that layer. Output(s) from the encoder 272 may also be fed into the multi-head attention block 274m. An addition and normalization block 274x may operate on the output of the addition and normalization block 274w and the output of multi-head attention block 274m. The output of the addition and normalization block 274x may be passed to the a feed forward block 274f in that layer. An addition and normalization block 274y may operate on the output of the addition and normalization block 274x and the output of the feed forward block 274f. The output of the addition and normalization block 274y may may be passed to a linear layer 274r, which may transform that output into a higher-dimensional space. The output of the linear layer 274r may be fed into a softmax layer 274s, which may be a non-linear activation function that normalizes the output to a probability distribution to ensure that all values are non-negative and add up to 1. Iterating the identical layers allows the model to learn complex patterns and relationships in the data.

Various types of transformer-based LLMs may be constructed by “stacking” the identical layers of the encoder 272 and/or the decoder 274 in particular arrangements and in combination with additional refinements/components. A given LLM constructed as such may then be trained or pre trained (e.g., using the AI architecture 260 of FIG. 2E, a similar AI architecture, a different AI architecture or a combination of some or all of these AI architectures) on a corpus of information and/or finetuned or instruction tuned to analyze/generate data (e.g., text, audio, and/or images).

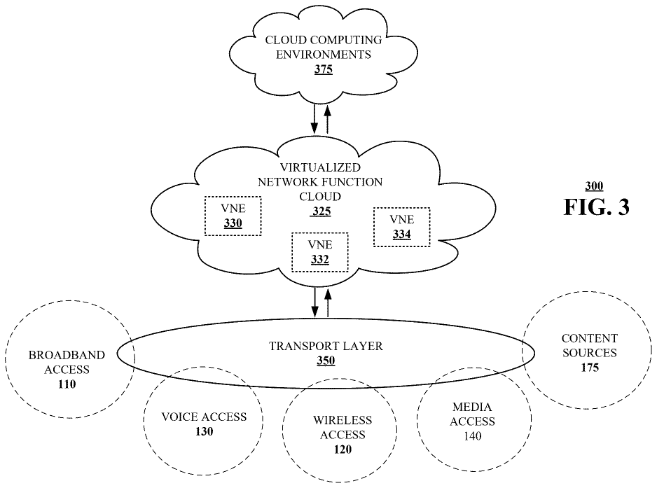

Referring now to FIG. 3, a block diagram 300 is shown illustrating an example, non-limiting embodiment of a virtualized communications network in accordance with various aspects described herein. In particular, a virtualized communications network is presented that can be used to implement some or all of the subsystems and functions of system 100, the subsystems and functions of system 200 and 225, and method 250 presented in FIGS. 1, 2A, 2C, and 2D. For example, virtualized communications network 300 can facilitate, in whole or in part, Gen AI-assisted alignment or adjustment of adaptive antenna(s).

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements - which are typically integrated to perform a single function, the virtualized communications network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward substantial amounts of traffic, their workload can be distributed across a number of servers - each of which adds a portion of the capability, and which creates an overall elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate, in whole or in part, Gen AI-assisted alignment or adjustment of adaptive antenna(s).

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), and an optical disk drive 420, (e.g., reading a CD-ROM disk 422 or, to read from or write to other high capacity optical media such as the DVD). The HDD 414, and optical disk drive 420 can be connected to the system bus 408 by a hard disk drive interface 424 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communications network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

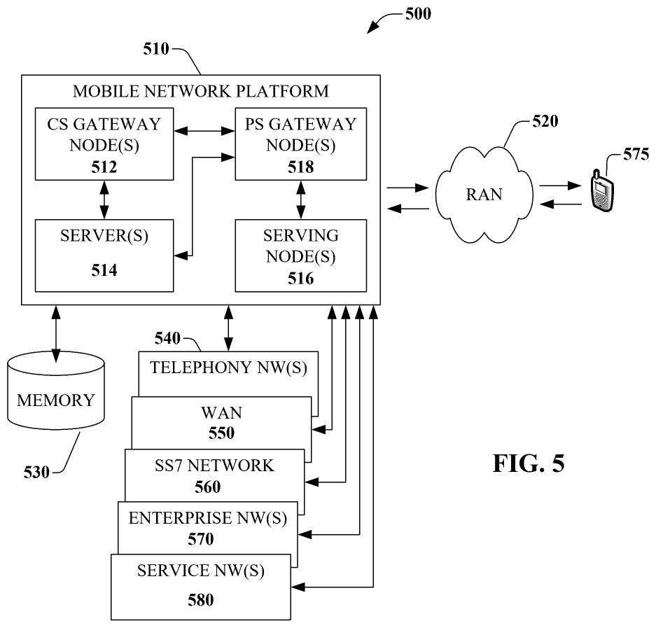

Turning now to FIG. 5, an embodiment 500 of a mobile network platform 510 is shown that is an example of network elements 150, 152, 154, 156, and/or VNEs 330, 332, 334, etc. For example, platform 510 can facilitate, in whole or in part, Gen AI-assisted alignment or adjustment of adaptive antenna(s). In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, which facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as distributed antenna networks that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

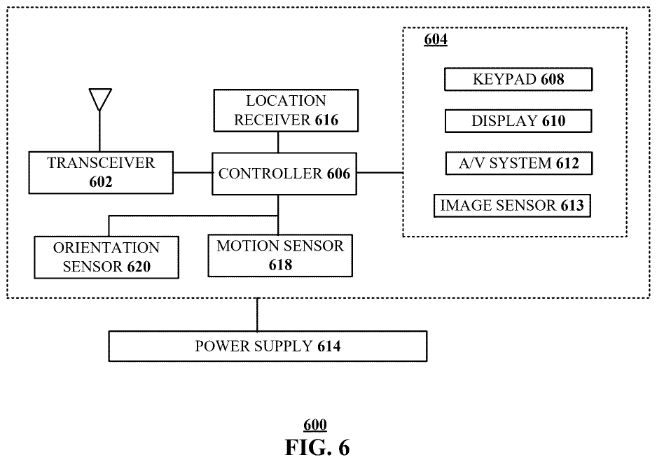

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via communications network 125. For example, computing device 600 can facilitate, in whole or in part, Gen AI-assisted alignment or adjustment of adaptive antenna(s).

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1×, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communications network) can employ various AI-based schemes for conducting various embodiments thereof. Moreover, the classifier can be employed to determine a ranking or priority of each cell site of the acquired network. A classifier is a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communications network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to,” “coupled to,” and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
receiving first data relating to a position or an orientation of one or more adaptive antennas and second data relating to one or more signals received via the one or more adaptive antennas;
causing an artificial intelligence (AI) model to generate a prediction for aligning or adjusting the one or more adaptive antennas based on the first data and the second data; and
based on the prediction, transmitting a command to an antenna controller unit to cause the one or more adaptive antennas to be aligned or adjusted.

2. The device of claim 1, wherein the first data comprises information regarding a bearing, a level, a height, or a combination thereof of the one or more adaptive antennas.

3. The device of claim 1, wherein the second data comprises signal strength information, interference level information, or a combination thereof.

4. The device of claim 1, wherein the one or more adaptive antennas comprises one or more adaptive antenna panels or sectors, one or more adaptive directional antennas, one or more adaptive parabolic antennas, or a combination thereof.

5. The device of claim 1, wherein the AI model has access to or is trained based on antenna-related data in an equipment library.

6. The device of claim 1, wherein the AI model has access to or is trained based on component specification data, component tolerance data, compliance data, or a combination thereof.

7. The device of claim 1, wherein the receiving the first data comprises receiving the first data from a digital bearing and level reading system, one or more sensors, one or more Internet-of-Things (IoT) devices, or a combination thereof.

8. The device of claim 1, wherein the receiving the second data comprises receiving the second data from a remote radio unit (RRU), a radio controller, a transceiver, or a combination thereof.

9. The device of claim 1, wherein the transmitting involves providing of the command to one or more test equipment that are communicatively coupled to the antenna controller unit, and wherein the providing results in the one or more test equipment generating a corresponding instruction for the antenna controller unit to effect alignment or adjustment of the one or more adaptive antennas.

10. The device of claim 1, wherein the operations further comprise, after the transmitting, obtaining additional data relating to a position or an orientation of the one or more adaptive antennas.

11. The device of claim 10, wherein the operations further comprise causing the additional data to be presented on a graphical user interface (GUI) of a user device.

12. The device of claim 1, wherein the AI model comprises a Large Language Model (LLM), a machine learning (ML) algorithm, or a combination thereof.

13. The device of claim 1, wherein the receiving, the causing, and the transmitting are performed during turnup of a cellular site, during testing of the cellular site, or both.

14. The device of claim 1, wherein the one or more adaptive antennas are located on a tower or a building structure.

15. The device of claim 1, wherein the one or more adaptive antennas are associated with a satellite system, a non-line-of-sight (NLOS) radio system, a broadcast microwave system, an amplitude modulation (AM) radio system, a frequency modulation (FM) radio system, a military communication system, or a combination thereof.

16. A non-transitory machine-readable medium, comprising executable instructions that, when executed by a processing system including a processor, facilitate performance of operations, the operations comprising:
receiving first data relating to a position or an orientation of one or more adaptive antennas and second data relating to one or more signals received via the one or more adaptive antennas, wherein the one or more adaptive antennas are composed of nanomaterial having a physical structure that is adjustable;
causing an artificial intelligence (AI) model to generate a prediction for modifying the physical structure based on the first data and the second data; and
based on the prediction, transmitting a command to an antenna controller unit to cause the physical structure to become adjusted.

17. The non-transitory machine-readable medium of claim 16, wherein the command identifies a particular electrical signal that, when applied to the nanomaterial, causes the physical structure thereof to change.

18. The non-transitory machine-readable medium of claim 16, wherein the nanomaterial comprises graphene, carbon nanotubes, or a combination thereof.

19. A method, comprising:
receiving, by a processing system including a processor, first data relating to a position or an orientation of one or more adaptive antennas and second data relating to one or more signals received via the one or more adaptive antennas;
causing, by the processing system, an artificial intelligence (AI) model to generate a prediction for adjusting the position or the orientation of the one or more adaptive antennas based on the first data and the second data; and
based on the prediction, transmitting, by the processing system, a command to an antenna controller unit to cause the position or the orientation of the one or more adaptive antennas to be adjusted.

20. The method of claim 19, wherein the one or more adaptive antennas are composed of nanomaterial having a physical structure that is adjustable, wherein the prediction further relates to adjustment of the physical structure, and wherein the command further triggers the antenna controller unit to cause the physical structure of the one or more adaptive antennas to become adjusted.
